(19) United States
(12) Patent Application Publication
(10) Pub. No.: US 2021/0082676 A1
(43) Pub. Date: Mar. 18, 2021

(54) LBMFI Detector for Fluorophore Labeled Analytes at the Taylor Cone in ESI-MS

(71) Applicant: DH TECHNOLOGIES DEVELOPMENT PTE. LTD., Singapore (SG)

(72) Inventors: Andras Guttman, San Diego, CA (US); Mate Szarka, San Diego, CA (US)

(21) Appl. No.: 17/041,330

(22) PCT Filed: May 23, 2019
(86) PCT No.: PCT/IB2019/054296

§ 371 Date: Sep. 24, 2020

Related U.S. Application Data
(60) Provisional application No. 62/680,554, filed on Jun. 4, 2018.

(51) Int. Cl. H01J 49/00; G01N 21/64; H01J 49/16; G01N 30/72

(52) U.S. Cl. CPC H01J 49/004; G01N 21/6456; H01J 49/165; G01N 2021/6439; H01J 49/164; H01J 49/0036; G01N 30/7233

(57) ABSTRACT

Fluorescently labeled molecules of a sample are quantitated in an ion source device of a mass spectrometer. An illumination source device to illuminates at least a first portion of a sample. The sample is illuminated to excite fluorescently labeled molecules of the sample as it is being ionized in the ion source device. A two-dimensional digital image detector measures an image of at least a second portion of the illuminated first portion of the sample at each time interval of a plurality of time intervals. Each measured image at each of the plurality of time intervals is stored in a memory device. A trace of the intensity of the second portion as a function of time is calculated from the stored measured images. A quantity of the fluorescently labeled molecules is calculated from the trace of the calculated intensity of the second portion as a function of time.

### RELATED APPLICATIONS

This application claims the benefit of U.S. Provisional Patent Application Ser. No. 62/680,554, filed on Jun. 4, 2018, the content of which is incorporated by reference herein in its entirety.

### INTRODUCTION

The teachings herein relate to systems and methods for quantitating fluorescently labeled molecules of a sample in an ion source device of a mass spectrometer. More particularly, the teachings herein relate to systems and methods for quantitating fluorescently labeled molecules of a sample compound in the ion source of a mass spectrometer just before mass analysis using laser beam mediated fluorophore imaging (LBMFI). The systems and methods herein can be performed in conjunction with a processor, controller, or computer system, such as the computer system of FIG. 1.

### CE-LIF-MS

Capillary electrophoresis (CE) in conjunction with laser-induced fluorescent (LIF) detection, for example, is a sensitive high performance bioanalytical technique. The separation is based on the differential electromigration of charged analyte molecules driven by the electric field gradient within a narrow bore capillary tubing. Coupling CE with mass spectrometry (MS) gives an additional separation dimension and information for structural elucidation of the sample components. However, due to the possibility of in-source degradation of labile compounds during the ionization process in the electrospray, simultaneous use of an optical detection system, such as fluorescence is highly advisable. In other words, CE with LIF detection before MS is advisable in order to detect the loss or degradation of sample components due to fragmentation in the ion source.

In the last two decades, MS started to be extensively used in the omics field, clinical, and regulatory laboratories as well as by the pharmaceutical industry. One of the main contributions triggering this domination was the invention of electrospray ionization (ESI) that made the detectable analyte mass range to grow far beyond 100 kDa. Also, the required sample concentration range reached as low as the picomolar levels. As a result, interconnecting CE with electrospray ionization (CE-ESI-MS) is a promising new technique for bimolecular analysis, especially with the CE-ESI-MS (CESI) interface in a single dynamic process. A few attempts have been made to couple CE-MS with a fluorescent or absorbance detector. However, one of the main drawbacks of this online detection attempts were the long capillary distance between the detection probe zone and the MS detector, resulting in different resolution and difficult traceability of the two traces generated. Some authors have reported progress in the field. Nevertheless, the application of the technology seems to remain limited, due to the complex instrumentational skill requirements.

Complex sugar structures, also referred to as glycans, attached to cell surface receptor proteins or extracellular proteins such as antibodies and have a large variety of specific biological functions. Sufficient and safe production of therapeutic antibodies require highly scrutinized quality control of these new class of drugs including a comprehensive analysis of their glycosylation. One of the most frequently used bioanalytical tools for glycosylation analysis is CE. Since carbohydrates in most instances are not charged and have no UV absorbing or fluorescent characteristics, they are labeled by a charged fluorophore via transfer hydrogenation. While optical detection of fluorophore-labeled carbohydrates provides quantitative distribution data of the sample components, the same in MS is dependent on the ionization process including ionization efficiency and may even cause structural changes by in-source degradation. These structural changes by in-source degradation can include loss of core fucosylation or antennary sialylation of important sugar structures, resulting in false results as was reported earlier in Wang et al., Journal of Separation Science, 36, (2013), 2862-2867 (hereinafter the “Wang Paper”). Therefore, simultaneous optical detection with the MS process is of high importance.

Unfortunately, there currently is no available method to simultaneously detect fluorescent analyte molecules, such as aminopyrenetrisulfonate labeled sugars, fluorescein-labeled proteins, peptides or metabolites, fluorophore intercalator labeled nucleic acids, for example, just immediately before getting them into the orifice of the mass spectrometer. In CE, so far the closest fluorescent detection was reportedly 12 cm from the orifice, and the detection was through the capillary material, i.e., glass. This caused a migration time shift between the optical and MS detection signals, in addition to the loss of detection sensitivity due to the presence of the glass capillary material at the point of detection.

Another general problem besides the solute specific ionization efficiency of MS for quantification is that some analyte molecules may lose certain labile residues, e.g., complex carbohydrates reportedly lost core fucose or terminal sialic acid units. Thus, without simultaneous optical detection, the resulting MS spectra may not represent the structure of the compound in hand.

As a result, there is a need for improved systems and methods to detect fluorescent analyte molecules right before these molecules enter into the mass spectrometer. In this way, the optical detection signal precisely corresponds to the MS detection signal, thus reveals any ionization mediated efficiency and structural changes as, e.g., loss of fucosylation or sialylation.

### SUMMARY

A system, method, and computer program product are disclosed for quantitating fluorescently labeled molecules of a sample in an ion source device of a mass spectrometer. All three embodiments include the following steps.

An illumination source device illuminates at least a first portion of a sample to excite fluorescently labeled molecules of the sample. The illumination source device illuminates the first portion as the sample is being ionized in an ion source device and before the sample enters a mass spectrometer.

One or more lenses are positioned between the first portion of the sample and a two-dimensional digital image detector. The one or more lenses focus at least a second portion of the first portion of the sample on the two-dimensional digital image detector.

The two-dimensional digital detector measures an image of the second portion at each time interval of a plurality of time intervals. One or more processors store each measured image at each of the plurality of time intervals in a memory device. The one or more processors calculate an intensity of the second portion of the sample as a function of time from the stored measured images. The one or more processors calculate a quantity of one or more of the fluorescently labeled molecules from the calculated intensity of the second portion as a function of time.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary capillary electrophoresis (CE) system 200.

FIG. 3 is a diagram from Szarka et al., Anal. Chem 2017, 89, 10673-10678, (hereinafter the “Szarka Paper”) showing the use of a smartphone charge-coupled device (CCD) detector in a CE system to detect an under-loaded sample.

FIG. 4 is a side view photograph and diagram of a capillary electrophoresis and electrospray ionization with laser beam mediated fluorophore imaging and mass spectrometry (CESI-LBMFI-MS) interface coupling of a CESI 8000 unit using the OptiMS capillary cartridge and the 6500+ QTRAP MS instrument, in accordance with various embodiments.

FIG. 5 is an image showing LBMFI of an aminopyrenetrisulfonate APTS labeled maltose sample, in accordance with various embodiments.

FIG. 6 is an alignment of plots of LBMFI and MS traces for the analysis of APTS labeled maltooligosaccharides, in accordance with various embodiments.

FIG. 7 is an alignment of plots of LBMFI and MS traces for the analysis of PNGaseF digested and APTS labeled Immunoglobulin G N-glycans, in accordance with various embodiments.

FIG. 8 is a schematic diagram of a system for quantitating fluorescently labeled molecules of a sample in an ion source device of a mass spectrometer, in accordance with various embodiments.

FIG. 9 is a flowchart showing a method for quantitating fluorescently labeled molecules of a sample in an ion source device of a mass spectrometer, in accordance with various embodiments.

FIG. 10 is a schematic diagram of a system that includes one or more distinct software modules that perform a method for quantitating fluorescently labeled molecules of a sample in an ion source device of a mass spectrometer, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

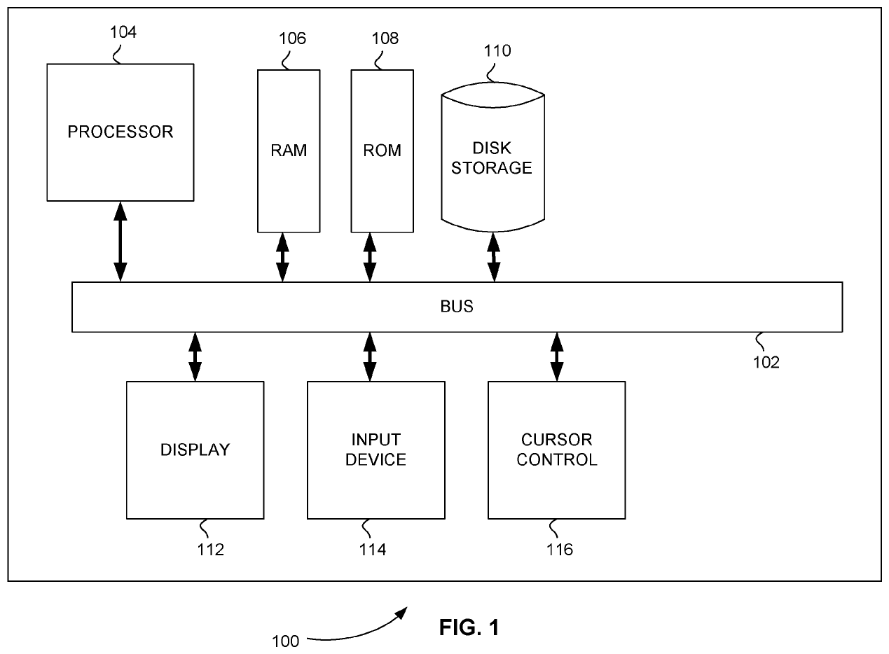

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory device 106, which can be a random access memory device (RAM) or other dynamic storage device, coupled to bus 102 for storing instructions to be executed by processor 104. Memory device 106 also may be used for storing temporary variables or other intermediate information during execution of instructions to be executed by processor 104. Computer system 100 further includes a read only memory device (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings Consistent with certain implementations of the present teachings, results are provided by computer system 100 in response to processor 104 executing one or more sequences of one or more instructions contained in memory device 106. Such instructions may be read into memory device 106 from another computer-readable medium, such as storage device 110. Execution of the sequences of instructions contained in memory device 106 causes processor 104 to perform the process described herein. Alternatively, hard-wired circuitry may be used in place of or in combination with software instructions to implement the present teachings. Thus implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory device, such as memory device 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory device card, a RAM, PROM, and EPROM, a FLASH-EPROM, any other memory device chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory device and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory device 106, from which processor 104 retrieves and executes the instructions. The instructions received by memory device 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory device (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### MS and MS/MS Background

In general, mass spectrometry, or MS, is a well-known technique for analyzing compounds. MS involves ionization of one or more compounds from a sample, producing precursor ions of the one or more compounds, and mass analysis of one or more of the precursor ions.

Tandem mass spectrometry, or MS/MS, involves ionization of one or more compounds from a sample, selection of one or more precursor ions of the one or more compounds, fragmentation of the one or more precursor ions into fragment or product ions, and mass analysis of the product ions.

MS and MS/MS can provide both qualitative and semi-quantitative information. Precursor or product ion spectra can be used to identify a molecule of interest. The intensity of one or more precursor or product ions can be used to quantitate the amount of the compound present in a sample.

### Separation Coupled MS and MS/MS Background

The combination of mass spectrometry (MS) (or mass spectrometry/mass spectrometry (MS/MS)) and a separation technique, such as CE or liquid chromatography (LC) is an important analytical tool for identification and quantification of compounds within a mixture. Generally, in liquid chromatography, for example, a fluid sample under analysis is passed through a column filled with a solid adsorbent material (typically in the form of small solid particles, e.g., silica). Due to slightly different interactions of components of the mixture with the solid adsorbent material (typically referred to as the stationary phase), the different components can have different transit (elution) times through the packed column, resulting in separation of the various components. In LC-MS, the effluent exiting the LC column can be continuously subjected to mass spectrometric analysis to generate an extracted ion chromatogram (XIC) or LC peak, which can depict detected ion intensity (a measure of the number of detected ions, total ion intensity or of one or more particular analytes) as a function of elution or retention time.

In some cases, the LC effluents can be subjected to tandem mass spectrometry (or mass spectrometry/mass spectrometry MS/MS) for the identification of product ions corresponding to the peaks in the XIC. For example, the precursor ions can be selected based on their mass/charge ratio to be subjected to subsequent stages of mass analysis. The selected precursor ions can then be fragmented (e.g., via collision-induced dissociation), and the fragmented ions (product ions) can be analyzed via a subsequent stage of mass spectrometry.

### Electrophoretic Systems and Methods

Electrophoretic methods are used to facilitate the detection of target analytes. Such methods exploit the fact that molecules in solution have an intrinsic electrical charge. Thus, in the presence of an electric field, each molecular species migrates with a characteristic “electrophoretic” mobility, which is dependent upon the hydrodynamic volume to charge ratio of the molecular species. When this ratio is different from among the various species present, they separate from one another. Under the influence of such a field, all of the variants will move toward a designated charge opposite to the charge of the variants; those having a lower electrophoretic mobility will move slower than, and hence be separated from, those having a (relative) higher electrophoretic mobility.

Electrophoresis has been used for the separation and analysis of mixtures. Electrophoresis involves the migration and separation of molecules in an electric field based on differences in mobility. Various forms of electrophoresis are known, including free zone electrophoresis, gel electrophoresis, isoelectric focusing, and isotachophoresis. In general, CE involves introducing a sample into a capillary tube, i.e., a tube having an internal diameter of from about 2 pm to about 2000 um (preferably, less than about 50 um; most preferably, about 25 pm or less) and applying an electric field to the tube (Chen, F-T. A., J. Chromatogr. 516:69*78 (1991); Chen, F-T. A., et al., J. Chromatogr. 15:1143*1161 (1992)). Since each of the sample constituents has its own individual electrophoretic mobility, those having greater mobility travel through the capillary tube faster than those with slower mobility. Hence, the constituents of the sample are resolved into discrete zones in the capillary tube during their migration through the tube. The method is well suited to automation since it provides convenient on-line injection, detection, and real-time data analysis.

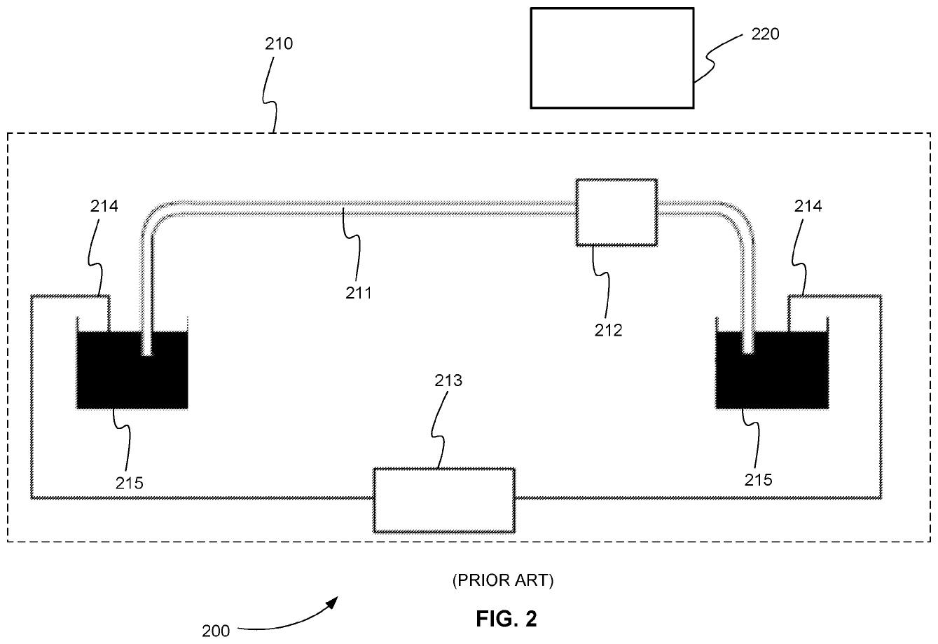

FIG. 2 is an exemplary CE system 200. CE system 200 includes CE device 210 and detector 220. CE device 210 includes fused-silica capillary 211 with optical viewing window 212, controllable high voltage power supply 213, two electrode assemblies 214, and two buffer reservoirs 215. The ends of capillary 211 are placed in the buffer reservoirs and optical viewing window 212 is aligned with detector 220, when detector 220 is an optical detector. After filling capillary 211 with buffer, the sample can be injected into capillary 211.

Electrophoresis is fundamentally the movement of charged particles within an applied electric field. In CE, a sample is injected at one end of capillary 211. Detector 220 is positioned or attached to capillary 211 at the other end of capillary 211 distant from the sample. A voltage, provided by high voltage power supply 213 and two electrode assemblies 214, is applied along the length of the capillary 211.

With the electric potential applied, two separate flow effects occur. The first of these flow effects is a gross sample flow effect. The sample moves as a mass into the capillary. The second of these flow effects is the electrophoretic flow. This causes the constituents of the sample having differing electric charges to move relative to the main stream of fluid within capillary 211. The portions of the sample having differing electric charge to hydrodynamic ratios are thereby separated in capillary 211.

Different detectors may be used to analyze the sample after the electrophoretic separation has occurred. These detectors can include, but are not limited to, an ultraviolet (UV) detector, a laser-induced fluorescence (LIF) detector, or a mass spectrometer. A UV detector, for example, is used to measure the amount of UV light absorbed by the separated sample. A LIF detector, for example, is used to provide a high-sensitivity measurement of labeled molecular species.

In a system that combines capillary electrophoresis with electrospray ionization (ESI) and mass spectrometry (MS), the output of the capillary is input to an electrospray assembly. The electrospray ionization is accomplished by placing a high voltage potential at the outlet of the separation capillary with respect to the capillary inlet to the mass spectrometer. The separation capillary also requires a high voltage potential placed between its inlet and outlet. The separated portions of the sample are dispersed by the electrospray into a fine aerosol as they exit the capillary. The droplets of the aerosol are then observed by mass spectrometry.

Compared to the early developmental instruments, fully automated CE devices offer computer control of all operations, pressure and electrokinetic injection, an autosampler and fraction collector, automated methods development, precise temperature control, and an advanced heat dissipation system. Automation is critical to CE since repeatable operation is required for precise quantitative analysis.

### CE with CCD Imaging

In the Szarka Paper, which is incorporated by reference herein, CE with charge-coupled device CCD imaging is described. The Szarka Paper is directed to applying digital imaging technology to solve the problem presented by an under- or overloaded sample in CE.

Conventional liquid chromatography (LC) and CE systems typically use diode array detectors (DAD), photomultiplier tubes (PMT) or avalanche photodiode (APD) to detect fluorescently labeled molecules. Unlike digital CCDs, DADs are unable to store raw images for postprocessing, however. As a result, if incorrect settings are applied or incorrect sample concentrations (under- or overloaded) are chosen in an LC or CE experiment, the experiment must be rerun. Repeating LC or CE experiments is expensive and time consuming. In addition, repeating experiments on precious samples may not even be possible.

In order to prevent repeating experiments due to under- or overloaded samples, the Szarka Paper describes modifying a CE system to use an inexpensive smartphone CCD detector. Using the CCD detector allows raw images of under- or overloaded samples to be stored. These raw images are then analyzed using signal processing algorithms to quantitate the under- or overloaded samples without having to repeat any experiments.

A blue LED (not shown) is used to illuminate portion 315 of capillary 310. In addition, an excitation filter (not shown) and a dichroic mirror (not shown) are used on the illumination side of capillary 310. The excitation filter and the dichroic mirror only allow green light to illuminate portion 315 of capillary 310.

On the detector side of capillary 310, light emitted by the fluorescently labeled molecules in capillary 310 is gathered by objective lens 320 and focused on CCD 330. Raw images from CCD 330 are sampled over time and sent to microcontroller 340. Microcontroller 340 is a Raspberry Pi-3 minicomputer. Microcontroller 340 stores the raw images and is used to post-process these stored images.

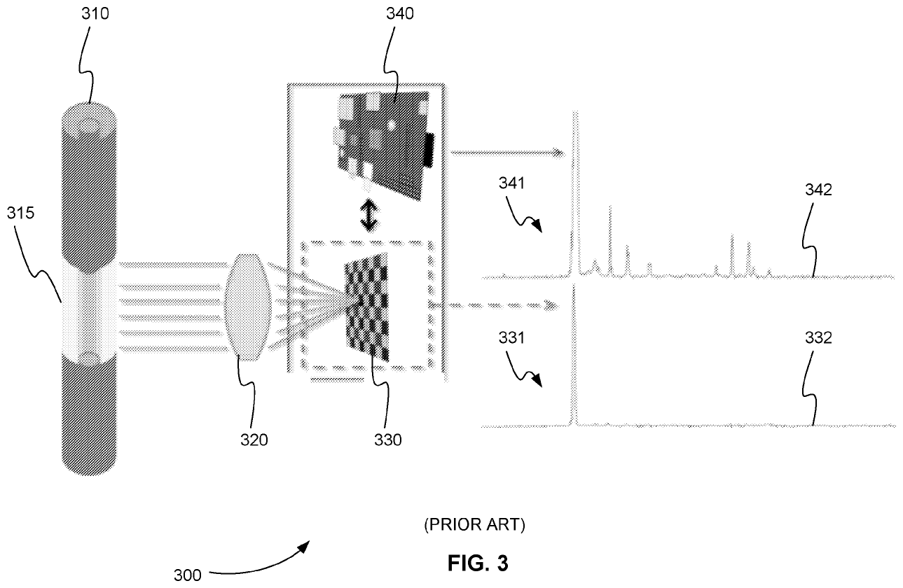

For example, FIG. 3 shows how microcontroller 340 uses post-processing to improve the results of an under-loaded or low concentration sample. Plot 331 depicts an unprocessed trace 332 of brightness versus time. In other words, trace 332 depicts the brightness determined from the raw data of CCD 330 over time. Because the sample concentration is low, trace 332 shows only one peak.

In contrast, plot 341 depicts a processed trace 342 of brightness versus time. Trace 342 is the result of microcontroller 340 applying a Positive Histogram Value Displacement (PHVD) algorithm to the stored raw data. In comparison to trace 332, trace 342 shows additional major peaks even though the sample concentration is low. Due to the post-processing of the raw data, there is no need to rerun the experiment.

### Systems and Methods for Detecting Fluorescent Analyte Molecules in an Ion Source

As described above, unfortunately, there currently is no available method to simultaneously detect fluorescent analyte molecules, such as aminopyrenetrisulfonate labeled sugars, fluorescein-labeled proteins, peptides or metabolites, fluorophore intercalator labeled nucleic acids, for example, just immediately before getting them into the orifice of the mass spectrometer. Also, some analyte molecules may lose certain labile residues, e.g., complex carbohydrates reportedly lost core fucose or terminal sialic acid units. Thus, without simultaneous optical detection, the resulting MS spectra may not represent the structure of the compound in hand. As a result, there is a need for improved systems and methods to detect fluorescent analyte molecules right before these molecules enter into the mass spectrometer

In various embodiments, a detection system detects fluorescent analyte molecules right at the point of ionization in an ion source. For example, in electrospray ionization (ESI) fluorescent analyte molecules are detected right at the Taylor cone of the electrospray itself, so immediately before these molecules enter into the mass spectrometer. In this way the optical detection signal precisely corresponds to the MS detection signal, thus revealing any ionization mediated efficiency and structural changes such as, e.g., loss of fucosylation or sialylation.

In addition, no material from a separation device is involved in the detection pathway since the detection is manifested in the spray itself. Material from a separation device can include, but is not limited to, column material from a liquid chromatography device or capillary material from a capillary electrophoresis device. In this way, quantitative profiling of fluorescent molecules is readily supported.

In one preferred embodiment, fluorescent analyte molecules are detected right at the point of ionization in an ion source using capillary electrophoresis with laser, LED or any other light beam mediated fluorophore imaging and electrospray ionization mass spectrometry (CE-LBMFI-ESI-MS). Such a system can be used to analyze linear and complex carbohydrates in the pM concentration range, for example.

A CESI 8000 (SCIEX, Brea, Calif.) capillary electrophoresis unit is used for separation with an OptiMS capillary cartridge and ESI interface connected to a 6500+ Qtrap (SCIEX) mass spectrometer, for example. For image acquisition based detection, a “spyglass” monocular setup is used.

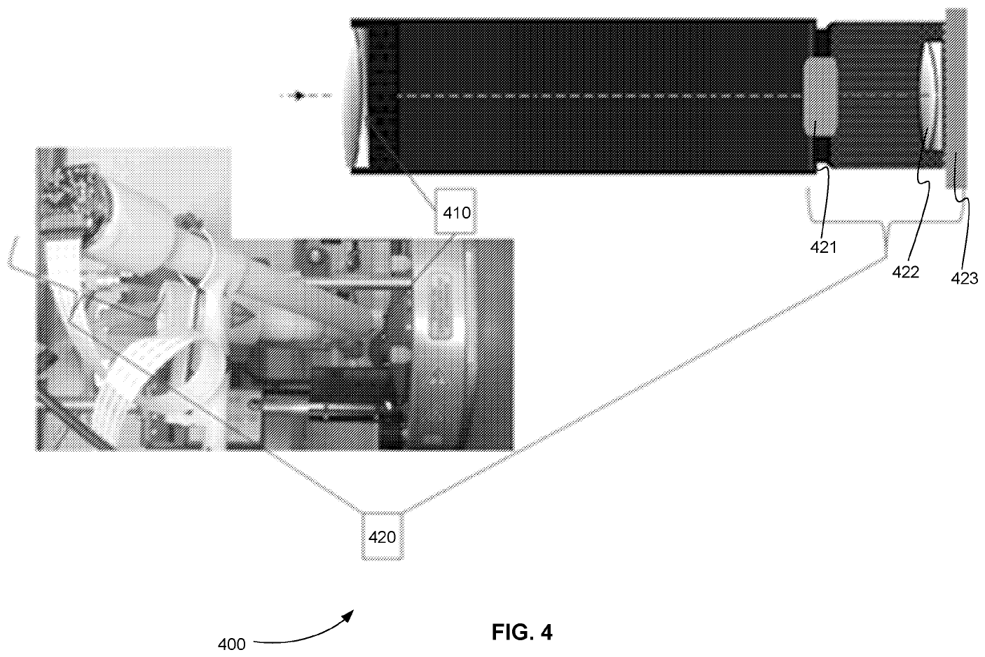

FIG. 4 is a side view 400 photograph and diagram of a CESI -LBMFI-MS interface coupling of a CESI8000 unit using the OptiMS capillary cartridge and the 6500+ QTRAP MS instrument, in accordance with various embodiments. Excitation at the Taylor cone is achieved via illumination with a 405 nm laser (not shown). The emitted light is transmitted to the smart imaging system via objective lens 410. During CESI-LBMFI-MS analysis, fluorescently labeled molecules sprayed through the Taylor cone are imaged through bandpass filter 421, eye lens 422, and CCD 423 of section 420.

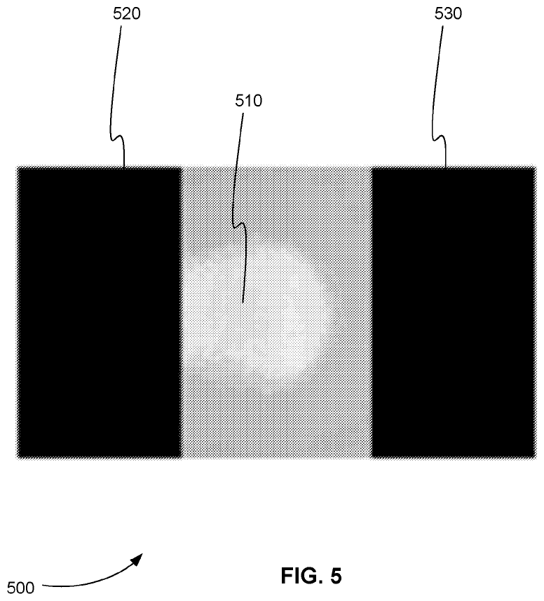

The monocular's objective lens 410 is approximately 3 cm away from the target, which is the end of the spray tip of the etched separation capillary (at the Taylor cone as depicted in FIG. 5 shown below). The Class 3b of 405 nm diode laser is driven at 3.0 V. It illuminates the spray zone with an azimuth angle of 85° and zenith angle of 60° from the tip. The monocular collects the emission light from the spray zone through a 12.5 mm diameter E0520/10 (EDMUNDS OPTICS INC., N.J., USA) emission filter 421. The collected and bandpass filtered light reaches the Pi NoIR SONY IMX219 8-megapixel CCD camera 423 (SONY SEMICONDUCTOR SOLUTIONS CO. Kanagawa, Japan) through the attached eye-lens 422. Considering the wide Stokes shift of the aminopyrenetrisulfonate (APTS)—sugar conjugate that is analyzed, using only one optical filter 421 provides sufficient signal.

FIG. 5 is an image 500 showing laser beam mediated fluorescent imaging (LBMFI) of an APTS labeled maltose sample, in accordance with various embodiments. FIG. 5 shows illuminated Taylor cone 510, which is the cone at the tip of a capillary from which a jet of ionized particles emanates. Blackened section 520 covers the end of the separation capillary. Blackened section 530 covers the orifice of the mass spectrometer.

As in the Szarka Paper, the imaging microcontroller is a credit card size, ARM cortex Raspberry Pi-3 minicomputer serving as pre-processor unit running the Raspbian (Raspberry Pi) operating system, for example. It is given commands through an SSH protocol from the client machine. Image processing is carried out by using the Raspistill library (Raspberry Pi) in time-lapse mode from the SSH terminal, Putty (Simon Tatham, Cambridge, UK). Images are produced in jpeg file-formats, for example.

Trigger signals and image-processing are executed by a client machine, controlling the CESI 8000 unit, for example. The electropherogram display and analysis scripts are written in Matlab (MathWorks Inc., Natick, USA) and ImageJ/Fiji (Wayne Rasband, NIH, Bethesda, USA) macro languages. Additional MIJ library (Biomedical Imaging Group, Lausanne, Switzerland) is used for interoperation between the Fiji and Matlab software.

The Fast Glycan Sample Preparation and Analysis Kit (SCIEX) protocol are used for the preparation of the APTS labeled maltooligosaccharide and IgG samples, for example.

CE is an excellent liquid phase separation tool capable of resolving linkage and positional isomers of fluorophore-labeled complex sugar molecules even with the exact same mass. ESI (Electrospray ionization) turns liquid samples into ionized aerosol form (gas-phase) by applying a high voltage to the sample at the spray tip. The electrospray process via the CESI interface of SCIEX couples the two analytical methods of CE and ESI into a single dynamic process. Also, during electrospray ionization in addition to the inherent solute dependent ionization rate, possible analyte in-source fragmentation can occur, which might make structural identification ambiguous. A good example of this is the loss of core fucosylation and sialylation during mass spectrometry of APTS labeled complex glycans as described above.

In various embodiments, fluorescence at the ion source allows precise determination of the optimal ionization energy to equalize the quality and quantity of peak intensities on both the CE and the MS sides. As FIG. 4 depicts, the presented setup utilizes the spray at the end of the separation capillary as the target to focus the bandpass filter, the eye lens, and the CCD in the light-path. The detection assembly is placed above the NanoSpray source on an adjustable bench via clamps on a separate 3D stage. It is carefully positioned relative to the MS orifice.

Before analysis, the separation capillary is flushed with 0.1M of NaOH and 0.1 M of HCl for 10 minutes, respectively, and finally with MQ water. After the rinsing process, the system is positioned in place, and the separation capillary, as well as the conductive capillary line, are filled with the appropriate background electrolyte. First, a water plug is injected into the separation capillary by applying 3 psi for 4 seconds, followed by electrokinetic injection of the sample by 10 kV for 20 seconds. The separation takes 40 minutes (recorded separation: 20 minutes) by applying 30 kV at 30° C. and results in well-resolved peaks of the APTS labeled maltooligosaccharide ladder both by fluorescent and MS detection.

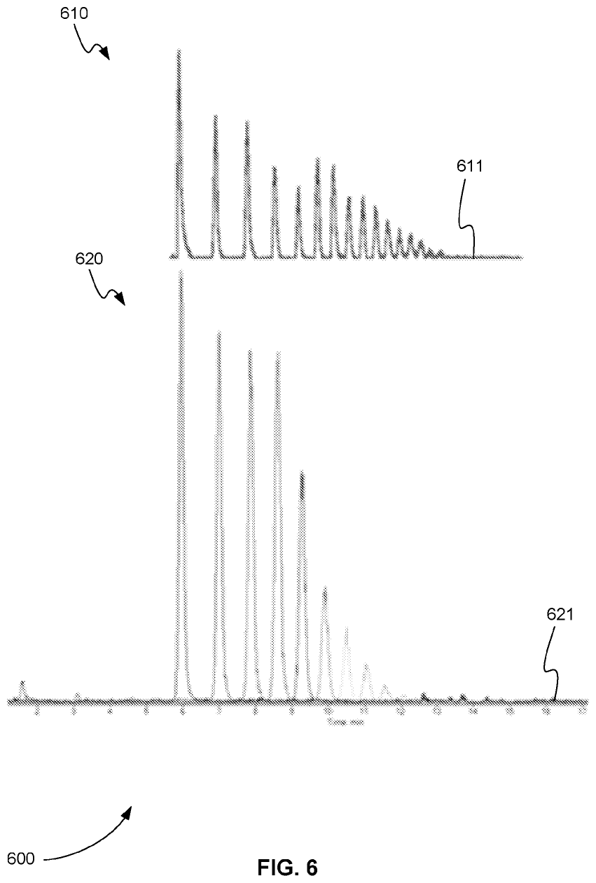

FIG. 6 is an alignment 600 of plots of LBMFI and MS traces for the analysis of APTS labeled maltooligosaccharides, in accordance with various embodiments. In plot 610, trace 611 shows the brightness versus time (electropherogram) measurements made by the CCD of LBMFI system described above. In plot 620, trace 621 shows the intensity versus time measurements (extracted ion chromatogram) made by the mass spectrometer analysis of the same sample. Alignment 600 shows that trace 611 and trace 621 both produce the same major maltooligosaccharide ladder peaks. This means that the LBMFI system of the ion source is able to accurately quantify fluorescent analyte molecules.

The short distance between the fluorescent detection in the Taylor Cone and the MS orifice (<5 mm) resulted in practically real-time image acquisition for the electropherogram along with the mass information for the sugar molecules.

Again, the conditions for the experiment producing trace 611 and trace 612 include: 7.5 mM ammonium acetate background electrolyte (pH 4.75); 90 cm effective length, 30 μm ID bare fused silica OptiMS capillary with the porous sprayer; injection: water plug 3 psi for 4 s, 10 kV for 20 s sample; applied voltage and pressure: 30 kV (cathode at the injection side) and 3 psi forward pressure during the separation; temperature: 30° C.

In another experiment, PNGaseF digested and APTS labeled Immunoglobulin G N-glycans are analyzed by the CESI-LBMFI-ESI-MS system of FIG. 4. The same conditions described above are used in this experiment also.

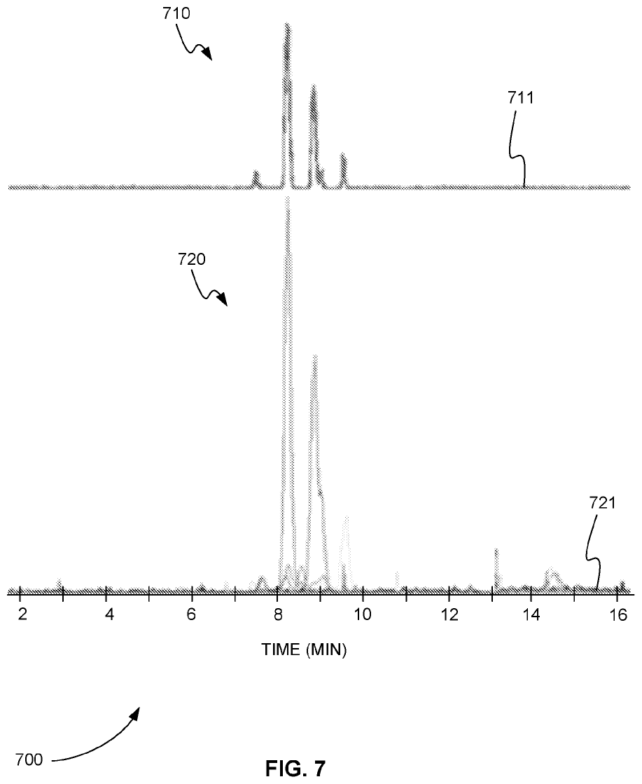

FIG. 7 is an alignment 700 of plots of LBMFI and MS traces for the analysis of PNGaseF digested and APTS labeled Immunoglobulin G N-glycans, in accordance with various embodiments. In plot 710, trace 711 shows the brightness versus time (electropherogram) measurements made by the CCD of LBMFI system described above. In plot 720, trace 721 shows the intensity versus time measurements (extracted ion chromatogram) made by the mass spectrometer analysis of the same sample. Alignment 700 shows a fragmentation pattern caused by ionization voltage induced changes in glycan structures appearing in MS trace 721 but not in LBMFI 711. Specifically, the ionization energy is higher than the optimum range for peak quantification. As a result, the peaks in the lower MS trace 721 between 14-15 min do not show up in the optical detection trace 711 and, therefore, do not represent fluorophore-labeled species, emphasizing the importance of the dual detection system presented here.

### System for Quantitating Fluorescently Labeled Molecules in an Ion Source

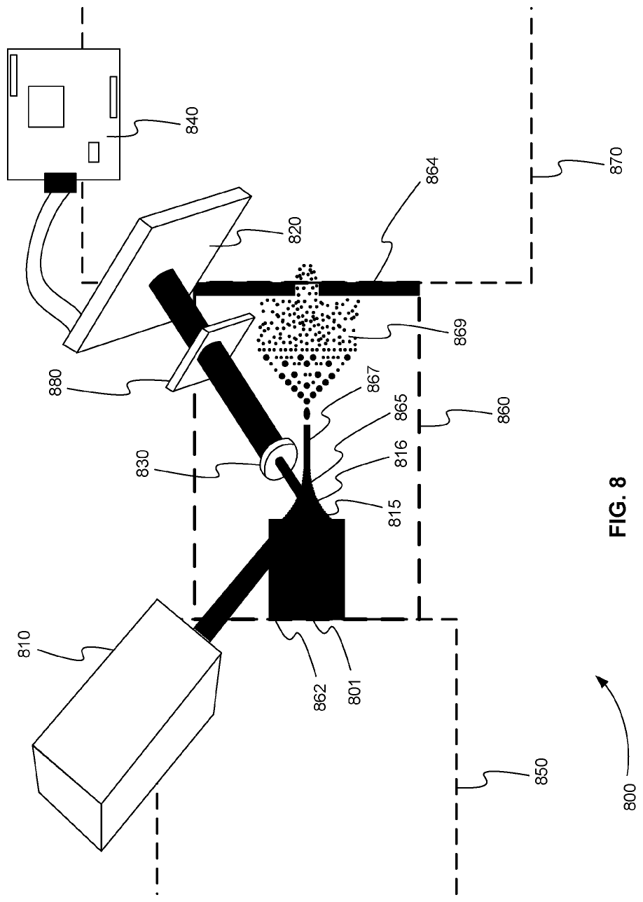

FIG. 8 is a schematic diagram 800 of a system for quantitating fluorescently labeled molecules of a sample in an ion source device of a mass spectrometer, in accordance with various embodiments. The system of FIG. 8 includes illumination source device 810, two-dimensional digital image detector 820, one or more lenses 830, and one or more processors 840.

Illumination source device 810 illuminates at least a first portion 815 of sample 801 to excite fluorescently labeled molecules of sample 801. Illumination source device 810 illuminates first portion 815 as sample 801 is being ionized in ion source device 860 and before the sample enters mass spectrometer 870. The fluorescently labeled molecules of sample 801 are a compound of interest or an analyte of sample 801, for example.

Illumination source device 810 can be any type of illumination source device capable of exciting the fluorescently labeled molecules of sample 801, including, but not limited to, a light emitting diode (LED) device or a laser. In various embodiments, illumination source device 810 is preferably a laser in order to allow illumination source device 810 to be positioned at a distance from sample 801.

Two-dimensional digital image detector 820 can be any type of two-dimensional digital image detector, including, but not limited to, a charge-coupled device (CCD), a complementary metal-oxide-semiconductor (CMOS) device, or a digital camera. In various embodiments, two-dimensional digital image detector 820 810 is preferably an inexpensive CCD of the type used in smartphones.

One or more lenses 830 are positioned between first portion 815 of sample 801 and two-dimensional digital image detector 820. For example, in FIG. 8 an objective lens 830 is shown positioned near first portion 815 of sample 801. In various embodiments, one or more lenses 830 can include an eye lens (not shown) near two-dimensional digital image detector 820 as described above.

One or more lenses 830 focus at least a second portion 816 of first portion 815 on two-dimensional digital image detector 820. Note that second portion 816 can be all or part of first portion 815.

Two-dimensional digital detector 820 measures an image of second portion 816 at each time interval of a plurality of time intervals. In other words, two-dimensional digital detector 820 images second portion 816 of sample 801 over time.

As described above and in various embodiments, illumination source device 810 images first portion 815 of sample 801 with a first frequency or wavelength. Two-dimensional digital image detector 820 then measures a second frequency or wavelength due the Stokes shift. The Stokes shift is a difference in frequency or wavelength due to the difference in absorption and emission of light by the fluorescently labeled molecules.

One or more processors 840 can include one or more of a computer, a microcontroller, a microprocessor, the computer system of FIG. 1, or any device capable of sending and receiving control signals and data and processing data. One or more processors 840 are in communication with illumination source device 810, two-dimensional digital detector 820, and with each other.

One or more processors 840 store each measured image at each of the plurality of time intervals in a memory device (not shown). The memory device can be a memory device of one or more of the one or more processors 840, a separate memory device, or remote memory device available across a communications channel, such as a cloud memory device.

As described above, in one embodiment, two processors are used. A microcontroller, such as an ARM cortex Raspberry Pi-3 imaging microcontroller is used for pre-processing. A client machine, controlling the CESI 8000 unit, is then used for control or trigger signals and image-processing. In various alternative embodiments, a single processor can be used.

One or more processors 840 calculate an intensity of second portion 816 as a function of time from the stored measured images. In various embodiments, one or more processors 840 can calculate an intensity of each image by calculating an area of two-dimensional digital detector 820 that receives a certain range of colors. As described in the Szarka Paper, each pixel of two-dimensional digital detector 820 can make a 24-bit measurement. This measurement is made up of three colors or channels, red, blue, and green. Each of the three colors can have an 8-bit value from 0 to 255. Each pixel also represents an area of two-dimensional digital detector 820.

If, for example, one or more processors 840 consider a measurement in each green channel of between 10 and 150 to represent a signal from the fluorescently labeled molecules of sample 801, then each pixel that makes a measurement within this range is considered to have measured the fluorescently labeled molecules.

In order to determine an intensity for the entire image, the area of each pixel is multiplied by the number of pixels considered to have measured the fluorescently labeled molecules. As a result, the intensity of each image is actually an area of each image. The areas of each of the measured stored images are then used to calculate an intensity of second portion 816 as a function of time.

One or more processors 840 calculate a quantity of the fluorescently labeled molecules from the calculated intensity of the second portion of 816 as a function of time. The calculated intensity of second portion 816 as a function of time is a trace such as trace 611 of FIG. 6 or trace 711 of FIG. 7. These traces include peaks.

One of ordinary skill in the art understands how a quantity of a known sample is determined from a peak of a measured trace. In various embodiments, for example, one or more processors 840 can calculate a quantity of the fluorescently labeled molecules by calculating areas of the peaks of these traces and comparing them to peaks measured from calibration samples of expected known compounds, for example.

In various embodiments, the system of FIG. 8 further includes a bandpass filter 880 positioned between second portion 816 and two-dimensional digital image detector 820. Bandpass filter 880 filters the light focused on two-dimensional digital image detector 880 to be within a specific frequency or wavelength range.

In various embodiments, sample 801 is introduced into the ion source 860 through an injection or separation device 850. A separation device can include, but is not limited to, a capillary electrophoresis (CE) device, a liquid chromatography (LC) device, or a mobility device.

In various embodiments, one or more processors 840 can include a processor of injection or separation device 850 or a processor of mass spectrometer 870.

In FIG. 8, illumination source device 810, two-dimensional digital image detector 820, one or more lenses 830, one or more processors 840, and bandpass filter 880 are shown outside of ion source device 860. In various embodiments, illumination source device 810, two-dimensional digital image detector 820, one or more lenses 830, one or more processors 840, and bandpass filter 880 are part of or integrated into ion source device 860. In addition, ion source device 860 can be part of or integrated into injection or separation device 850 or mass spectrometer 870.

Ion source device 860 can be any type of ion source device, including, but not limited to, an electrospray ionization (ESI) ion source device, a matrix-assisted, laser desorption ionization (MALDI) ion source device, an electron ionization (EI) ion source device, a chemical ionization (CI) ion source device, or an inductively coupled plasma ionization (ICP) ion source device.

In various embodiments, and as shown in FIG. 8, ion source device 860 is preferably an ESI ion source device. The ESI ion source device includes capillary 862 and reduction metal plate 864. Sample 801 emanates from ESI ion source device capillary 862 as Taylor cone 865, jet 867 and plume 869.

In a preferred embodiment, second portion 816 of sample 801 is an area of Taylor cone 865. Since second portion 816 includes part of or all of first portion 815, first portion 815 of sample 801 also must include an area of Taylor cone 865. Imaging Taylor cone 865 is preferred because fragmentation is more likely to occur in jet 867 or plume 869. However, in various alternative embodiments, jet 867 or plume 869 can be illuminated and imaged.

In various embodiments, one or more processors 840 receive an extracted ion chromatogram (XIC) calculated from measurements made by mass spectrometer 870 for the fluorescently labeled molecules and compare the XIC to the calculated intensity of second portion 816 as a function of time.

Mass spectrometer 870 can be, but is not limited to, a time-of-flight (TOF), quadrupole, an ion trap, a linear ion trap, an orbitrap, or a Fourier transform mass spectrometer.

### Method for Quantitating Fluorescently Labeled Molecules in an Ion Source

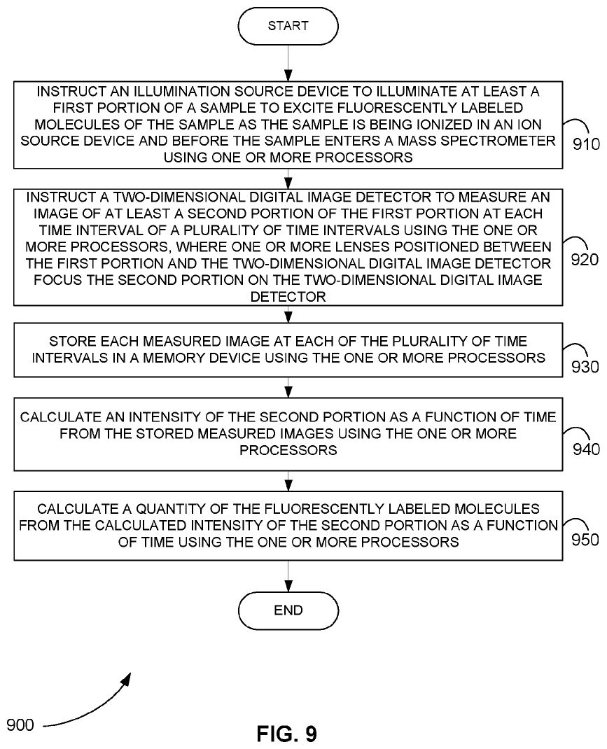

FIG. 9 is a flowchart showing a method 900 for quantitating fluorescently labeled molecules of a sample in an ion source device of a mass spectrometer, in accordance with various embodiments.

In step 910 of method 900, an illumination source device is instructed to illuminate at least a first portion of a sample using one or more processors. The sample is illuminated to excite fluorescently labeled molecules of the sample as the sample is being ionized in an ion source device and before the sample enters a mass spectrometer.

In step 920, a two-dimensional digital image detector is instructed to measure an image of at least a second portion of the first portion at each time interval of a plurality of time intervals using the one or more processors. One or more lenses are positioned between the first portion and the two-dimensional digital image detector to focus the second portion on the two-dimensional digital image detector.

In step 930, each measured image at each of the plurality of time intervals is stored in a memory device using the one or more processors.

In step 940, an intensity of the second portion as a function of time is calculated from the stored measured images using the one or more processors.

Finally, in step 950, a quantity of the fluorescently labeled molecules is calculated from the calculated intensity of the second portion as a function of time using the one or more processors.

### Computer Program Product for Identifying a Glycan

In various embodiments, computer program products include a tangible computer-readable storage medium whose contents include a program with instructions being executed on a processor so as to perform a method for quantitating fluorescently labeled molecules of a sample in an ion source device of a mass spectrometer. This method is performed by a system that includes one or more distinct software modules.

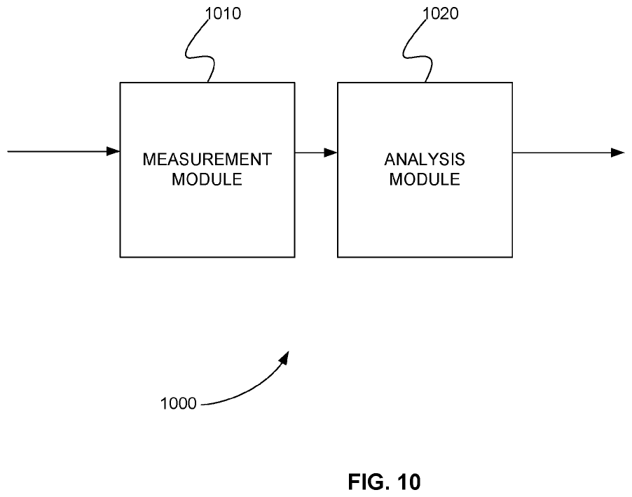

FIG. 10 is a schematic diagram 1000 of a system that includes one or more distinct software modules that perform a method for quantitating fluorescently labeled molecules of a sample in an ion source device of a mass spectrometer, in accordance with various embodiments. System 1000 includes measurement module 1010 and analysis module 1020.

Measurement module 1010 instructs an illumination source device to illuminate at least a first portion of a sample. The sample is illuminated to excite fluorescently labeled molecules of the sample as the sample is being ionized in an ion source device and before the sample enters a mass spectrometer.

Measurement module 1010 instructs a two-dimensional digital image detector to measure an image of at least a second portion of the first portion at each time interval of a plurality of time intervals. One or more lenses are positioned between the first portion and the two-dimensional digital image detector to focus the second portion on the two-dimensional digital image detector. Measurement module 1010 stores each measured image at each of the plurality of time intervals in a memory device.

Analysis module 1020 calculates an intensity of the second portion as a function of time from the stored measured images. Finally, analysis module 1020 calculates a quantity of the fluorescently labeled molecules from the calculated intensity of the second portion as a function of time.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for quantitating fluorescently labeled molecules of a sample in an ion source device of a mass spectrometer, comprising:
an illumination source device that illuminates at least a first portion of a sample to excite fluorescently labeled molecules of the sample as the sample is being ionized in an ion source device and before the sample enters a mass spectrometer;
a two-dimensional digital image detector;
one or more lenses positioned between the first portion and the two-dimensional digital image detector, wherein the one or more lenses focus at least a second portion of the first portion on the two-dimensional digital image detector and the two-dimensional digital detector measures an image of the second portion at each time interval of a plurality of time intervals; and
one or more processors that store each measured image at each of the plurality of time intervals in a memory device, calculate an intensity of the second portion as a function of time from the stored measured images, and calculate a quantity of the fluorescently labeled molecules from the calculated intensity of the second portion as a function of time.

2. The system of claim 1, further comprising a bandpass filter positioned between the second portion and the two-dimensional digital image detector, wherein the bandpass filter filters the light focused on the two-dimensional digital image detector to be with a specific frequency range.

3. The system of claim 1, wherein the illumination source device comprises a laser.

4. The system of claim 1, wherein the sample is introduced into the ion source device through an injection device.

5. The system of claim 1, wherein the sample is introduced into the ion source device through a separation device.

6. The system of claim 5, wherein the separation device comprises a capillary electrophoresis (CE) device.

7. The system of claim 5, wherein the separation device comprises a liquid chromatography (LC) device.

8. The system of claim 5, wherein the one or more processors include a processor of the separation device.

9. The system of claim 1, wherein the ion source device comprises an electrospray ionization (ESI) ion source device.

10. The system of claim 1, wherein the second portion comprises an area of a Taylor cone of the sample.

11. The system of claim 1, wherein the one or more processors include a processor of the mass spectrometer.

12. The system of claim 1, wherein the one or more processors receive an extracted ion chromatogram (XIC) calculated from measurements made by the mass spectrometer for the fluorescently labeled molecules and compare the XIC to the calculated intensity of the second portion as a function of time.

13. The system of claim 1, wherein the ion source device comprises a matrix-assisted, laser desorption ionization (MALDI) ion source device.

14. A method for quantitating fluorescently labeled molecules of a sample in an ion source device of a mass spectrometer, comprising:
instructing an illumination source device to illuminate at least a first portion of a sample to excite fluorescently labeled molecules of the sample as the sample is being ionized in an ion source device and before the sample enters a mass spectrometer using one or more processors;
instructing a two-dimensional digital image detector to measure an image of at least a second portion of the first portion at each time interval of a plurality of time intervals using the one or more processors, wherein one or more lenses positioned between the first portion and the two-dimensional digital image detector focus the second portion on the two-dimensional digital image detector;
storing each measured image at each of the plurality of time intervals in a memory device using the one or more processors;
calculating an intensity of the second portion as a function of time from the stored measured images using the one or more processors; and
calculating a quantity of the fluorescently labeled molecules from the calculated intensity of the second portion as a function of time using the one or more processors.

15. A computer program product, comprising a non-transitory tangible computer-readable storage medium whose contents include a program with instructions being executed on a processor so as to perform a method for quantitating fluorescently labeled molecules of a sample in an ion source device of a mass spectrometer, comprising:
providing a system, wherein the system comprises one or more distinct software modules, and wherein the distinct software modules comprise a measurement module and an analysis module;
instructing an illumination source device to illuminate at least a first portion of a sample to excite fluorescently labeled molecules of the sample as the sample is being ionized in an ion source device and before the sample enters a mass spectrometer using the measurement module;
instructing a two-dimensional digital image detector to measure an image of at least a second portion of the first portion at each time interval of a plurality of time intervals using the measurement module, wherein one or more lenses positioned between the first portion and the two-dimensional digital image detector focus the second portion on the two-dimensional digital image detector;
storing each measured image at each of the plurality of time intervals in a memory device using the measurement module;
calculating an intensity of the second portion as a function of time from the stored measured images using the analysis module; and
calculating a quantity of the fluorescently labeled molecules from the calculated intensity of the second portion as a function of time using the analysis module.
